(19) United States
(12) Patent Application Publication
(10) Pub. No.: US 2008/0093773 A1
(43) Pub. Date: Apr. 24, 2008

(54) Reverse Motion Valve Gating System

(75) Inventor: Udo SCHWARZKOPF, Fairfax, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems, Ltd., Bolton (CA)

(21) Appl. No.: 11/550,974

(22) Filed: Oct. 19, 2006

(51) Int. Cl. B29C 45/00

(52) U.S. Cl. 264/328.11; 425/566

(57) ABSTRACT

An improved injection molding method and valve gating system are provided for a mold cavity using a valve gated nozzle wherein a valve stem is stationary with respect to a nozzle and the mold gate may be positioned to move relative to the valve stem to open and close the gate.

### TECHNICAL FIELD

The present disclosure relates to an injection molding system and, more particularly, to a valve gating system wherein the valve gating portion is stationary with respect to the nozzle.

### BACKGROUND INFORMATION

Injection molding nozzles are well known and may be used to inject materials into cavities of a mold. For example, such nozzles may receive molten material, such as plastic, metal, or the like, from an injection molding machine and direct the same into mold cavities through passages called gates. When an injection operation is complete, and prior to opening the mold cavity to eject the molded parts, the transfer of molten material through the gates must be stopped. Generally, two methods exist for stopping the transfer of molten material through the gates, namely; thermal, or open, gating and valve gating.

In thermal gating, the gate is an open aperture through which molten material passes during an injection operation. The gate may be rapidly cooled at the end of the injection portion of the cycle, when the injection pressure is removed, to “freeze” the injected material into a plug. This plug may remain in the gate to prevent drool of molten material from the gate when the mold is open for the ejection of the molded part. In the next injection portion of the cycle, the cooling applied to the gate may be effectively removed and hot molten material from the injection molding machine may push the remaining plug into the mold cavity, where it may melt and mix with the newly provided molten material.

In valve gating, the opening and closing of the gate may be independent of injection pressure and/or cooling and may be achieved mechanically with a valve stem or the like. This stem may be moved between an open position, wherein flow of molten materials through the gate is permitted, and a closed position wherein the gate is closed by entry of the valve stem into the gate which establishes a seal, preventing molten materials from passing through the gate. Valve gating is well known and examples of such systems are shown in U.S. Pat. Nos. 2,878,515; 3,023,458; and 3,530,539, each being incorporated herein by reference.

Generally, for situations that require improved aesthetics, valve gating may be preferable to thermal gating because it may reduce the undesired gate vestige which results on the finished molded part. However, there may be problems with valve gating systems.

In general, machines for injection molding of plastics articles include a pair of platens that are spaced from each other and that are interconnected by generally four parallel tie bars that have their axes positioned to define a generally rectangular array. One of the platens remains stationary and may be adapted to support one portion of a two or multiple piece injection mold that when assembled or engaged defines at least one mold cavity (typically a plurality of mold cavities) to correspond with the outline of a desired molded part(s). A movable platen may be slidably carried on the tie bars and may be adapted to carry a cooperating portion of the mold so that when the movable platen is moved toward the mold-portion-carrying fixed platen the two mold portions come into contact to define there between a mold cavity(ies) for forming the desired part(s). Additionally, stacked hot runner and molds (such as, but not limited to, the Tandem Molding System by Husky Injection Molding Systems Ltd.) allow for the simultaneous operation of two or more molds in one machine.

The movable platen may generally be a plate-like structure that is of rectangular configuration and may include four bores at the respective corners, through each of which a tie bar extends. A movable platen actuation system may be positioned between the non-mold-carrying fixed platen and the movable platen to cause the movable platen to move along the tie bars toward or away form the mold platen, and also to hold the movable platen firmly in position when the mold portions are together, to prevent separation of the molds as molten material is injected into the mold cavity under high pressure.

Attached to the stationary platen, and in fluid communication with the mold cavity, is an injection unit which may selectively provide molten resin through an injection nozzle assembly (typically having a plurality of nozzles each in fluid communication with a mold cavity) to the mold cavity(ies) under high pressure and temperature for the formation of an injection molded article(s). As the high pressure resin enters the mold cavity(ies), the pressure acts to separate the two faces of mold halves. It is this injection pressure that the clamping force generated by clamp column must resist.

Each valve stem in the nozzle assembly may require a pneumatic or hydraulic actuator mechanism to control the movement and subsequent opening or closing of the gate or mechanical plate. Control of the flow rate of the molten plastic entering the mold cavity(ies) using these actuator mechanisms may be difficult. Further, since the valve stem may contact the sealing portion of the gate, the stem may become misaligned and even cause wear to the gate sealing area.

Moreover, a nozzle assembly may comprise a plurality of nozzles as mentioned above. For a variety of reasons, each nozzle of the nozzle assembly may include a dedicated/separate actuator mechanism that controls the movement of the valve stem. Each actuator mechanism may need to be connected to power source/line (such as electrical power) and/or pneumatic or hydraulic lines and may result in significant duplication of parts. This duplication of parts may add considerable expense to the construction as well as the maintenance of the nozzle system and also may reduce the overall lifespan of the nozzle system. Additionally, routing all of the necessary lines may be difficult or impossible given the limited amount of space in many applications. As a result, the routing may add further costs to the construction of the nozzle system and may limit the number of nozzles that may be placed in a single nozzle system therefore requiring additional injection molding machines in order to achieve the desired output production.

Therefore, there exists a need for an improved design that obviates or reduces some of these drawbacks. According to one embodiment, the improved design is directed at a stationary valve stem/nozzle assembly which acts to open or close a gate by relative movement of the gate against than the nozzle and valve stem, rather than the more conventional movement of the valve stem within the nozzle assembly to seal against the gate area.

It is important to note that the present disclosure is not intended to be limited to an apparatus, system or method which must satisfy one or more of any stated objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

In accordance with one aspect, a method may comprise transporting a molten material from a nozzle assembly to a mold cavity of an injection mold and moving the injection mold to a first position (for example by an actuator coupled to the injection mold) wherein a portion of the injection mold contacts a portion of the nozzle assembly and prevents the flow of the molten material into the mold cavity. The portions of the injection mold and the nozzle assembly that contact may include a gate region and stationary nozzle stem or nozzle tip, respectively. The injection mold may also be moved to a second position (for example by an actuator coupled to the injection mold) wherein the portions of the injection mold and the nozzle assembly do not contact each other. The actuator may also open and close the injection mold.

In accordance with another aspect, a nozzle assembly may comprise a nozzle comprising and a valve gating portion. The nozzle may include a nozzle body having an internal flow channel configured to communicate resin from a source of resin with a mold cavity of an injection mold. The valve gating portion is stationary with respect to the nozzle body and may be configured to engage the injection mold in a first position and prevent resin from flowing to the mold cavity.

The valve gating portion may optionally comprise a valve stem mounted within the internal flow channel and extending outward from an injection orifice of the nozzle. Alternatively, the valve gating portion may comprise a nozzle tip removeably secured to a distal end of the nozzle body. A bushing may be configured to be secured to the injection mold and to surround at least a portion of an exterior surface of the nozzle. An actuator may move the injection mold and the bushing between the first and the second positions.

In accordance with a further aspect, a valve gating system may comprise an injection mold, a nozzle assembly, and an actuator. The injection mold may include a mold cavity and a gate. The nozzle assembly may include a nozzle body having an internal flow channel configured to communicate resin from a source of resin with the mold cavity of the injection mold and a valve gating portion that is stationary with respect to the nozzle body. The actuator may be coupled to the injection mold and configured to move the injection mold relative to the nozzle assembly between a first position wherein the valve gating portion engages the gate of injection mold and prevents resin from flowing to the mold cavity and a second position wherein the valve gating portion permits the resin to flow into the mold cavity.

The injection mold may comprise a mold plate and a cavity plate defining the mold cavity. The actuator may be coupled to the injection mold to move at least one of the mold and the cavity plates between an open and a closed position. The actuator may be coupled to the injection mold such that the injection mold is simultaneously in the open position and the first position. Alternatively, the actuator may be coupled to the injection mold such that the injection mold is simultaneously in the closed position and the first position.

The valve gating portion may include a valve stem mounted within the internal flow channel and extending outward from an injection orifice of the nozzle. Alternatively, the valve gating portion may comprise a nozzle tip removeably secured to a distal end of the nozzle body. Optionally, a bushing may be configured to be secured to the injection mold and to surround at least a portion of an exterior surface of the nozzle. The bushing moves along a portion of the nozzle as the injection mold moves between the first and the second positions.

### BRIEF DESCRIPTION OF THE DRAWINGS

These and other features and advantages of the present disclosure will be better understood by reading the following detailed description, taken together with the drawings wherein:

FIG. 1 is a sectional view of one embodiment of the valve gating system of the present disclosure with the valve gate closed and the valve gating portion engaged with the gate;

FIG. 2 is a sectional view of one embodiment of the valve gating system of the present disclosure with the valve gate open and the gate retracted from the valve gating portion and nozzle;

FIG. 3 is a sectional view of one embodiment of the valve gating system of the present disclosure with the valve gate open in an injection-compression molding machine;

FIG. 4 is a section view of another embodiment of the valve gating system of the present disclosure with the valve gating portion retracted from the gate; and

FIG. 5 is a section view of another embodiment of the valve gating system of the present disclosure with the valve gating portion engaged with the gate.

### DETAILED DESCRIPTION OF THE PREFERRED EMBODIMENTS

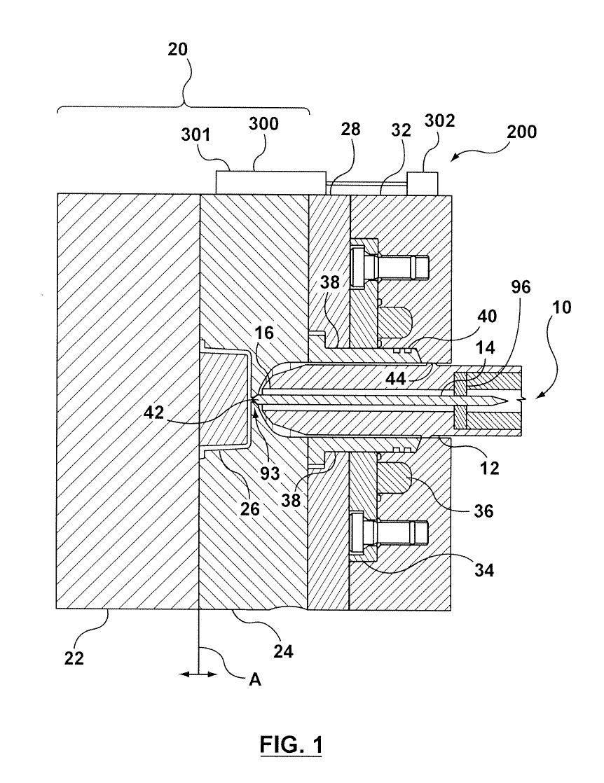

A sectional view of one embodiment of an injection nozzle assembly 10 is shown in FIG. 1 installed in an injection molding machine which includes an injection mold 20. The injection mold 20 may include a core plate 22 and cavity plate 24 which cooperate to form a mold cavity space 26 in the shape of a part which is to be molded of plastic. The core plate 22 may be mounted on a movable platen (not shown) for separating the mold core plate 22 and mold cavity plate 24 along split line A for removal of the molded part. The injection molding machine is shown in a condition where the mold halves (core plate 22 and cavity plate 24) are closed or engaged to form cavity space 26 and the nozzle assembly 10 is engaged with the injection mold 20 such that resin cannot flow from the nozzle assembly 10 into the mold cavity 26.

A stationary platen 30, which the nozzle assembly 10 extends through, may include a bushing plate 32, a retainer plate 34 and a cooling device 36. Attached to the cavity plate 24 may be an adapter plate 28 which engages a bushing 38 that surrounds at least a portion of the nozzle assembly 10. The bushing 38 may include seals 40 (such as metallic seals or the like) which engage the bushing plate 32.

The nozzle assembly 10 may comprise a nozzle body or tip 12 and a melt channel 16 which communicates molding material (for example, but not limited to, plastic) from the injection unit (not shown) to the mold cavity space 26 through a gate 42. According to one embodiment, the melt channel 16 may run the length of the nozzle assembly 10. Alternatively, the melt channel 16 may run only partially through the length of the nozzle assembly 10. The nozzle assembly 10 may also include one or more seals 44 to the bushing plate 32 to substantially prevent leakage of resin past the nozzle assembly 10.

The nozzle assembly 10 also includes a valve gating portion 93 for controlling the flow of resin into the mold cavity 26. According to one embodiment, the valve gating portion 93 may comprise a stationary valve stem 14 which may be at least partially located within the melt channel 16. The valve stem 14 may be secured (either removeably or permanently) to part of the nozzle assembly 10 (for example using a mounting flange 96) or may be formed as a unitary, single part of the nozzle assembly 10. While the valve stem 14 is shown substantially axially with the melt channel 16, other arrangements of the valve stem 14 with respect to the nozzle tip are possible and are considered within the scope of the present disclosure. For example, the valve stem 14 may be disposed at an angle with respect to the nozzle tip 12 and/or the melt channel 16.

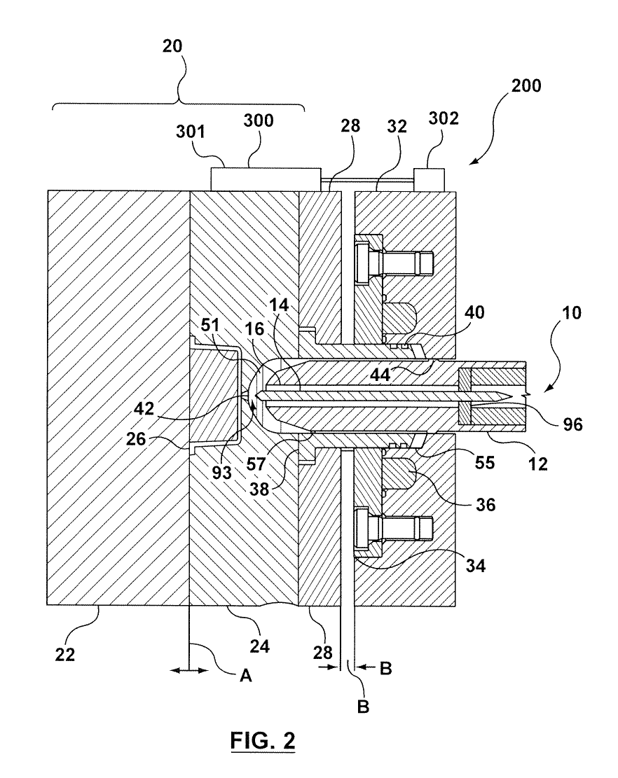

According to one embodiment, a portion of the valve stem 14 may extend beyond the outlet of the melt channel 16. Alternatively, the valve stem 14 may be substantially entirely disposed within the melt channel 16. When the injection molding machine is in the closed position shown in FIG. 1, a portion of the valve stem 14 may seat against a portion of the gate 42 thereby sealing the gate 42 independent of the shape of the seat. As a result, resin cannot flow from the melt channel 16 into the mold cavity 26. Rather than relying upon individual actuators connected to each valve stem to retract the valve stem and open the gate 42 as discussed above, the valve stem 14 and nozzle tip 12 according to the present disclosure are stationary relative to one another and the injection mold 20 (for example the gate 42) may be moved relative to the nozzle assembly 10 and valve stem 14. The injection mold 20 (i.e., the gate 42) may be moved from the closed position as shown in FIG. 1 to the open position as shown in FIG. 2 wherein a path is provided for the flow of molten resin into the mold cavity 26 and to form a molded article.

Referring now to FIG. 2, the combination of core plate 22 and cavity plate 24 (along with adaptor plate 28 and bushing 38) may be moved slightly away from stationary platen 30 to allow the nozzle assembly 10 (for example the nozzle 12 and valve stem 14) to retract sufficiently from the cavity plate 24 and gate 42, respectively, to allow for the flow of molten resin from the injection unit through the melt channel 16 around the valve stem 14, through the gate 42 and into the mold cavity space 26. A bushing 44, shaped to substantially complement the tip of the nozzle body 12, may be used to provide a sealing surface for the nozzle body 12 when the valve stem 14 engages and seals the gate 42.

The amount that the gate 42 may be moved relative to the nozzle body 12 and valve stem 14 may be quite small, for instance, about 0.11 inches to about 0.22 inches, to open and close the gate. Of course, the gate 42 may be move more or less depending upon the intended application. According to one embodiment, this distance may be regulated by the mold clamping system.

Thus, rather than relying on pneumatic or hydraulic actuators to retract the valve stem 14 within the nozzle body 12 to allow material to flow through the gate 42, the injection mold 20 may be moved relative to the nozzle assembly 10. According to one embodiment, an actuator mechanism 200 of the injection molding machine may be coupled to the injection mold 20 and/or the bushing plate 32 to move the injection mold 20 relative to the nozzle assembly 10. The actuator mechanism 200 may also be used to separate the mold plates 22, 24 from the stationary platen along split line B to allow material to flow into the mold cavity space 26. Any modifications to the injection molding machine are considered within the knowledge of one of ordinary skill in the art in view of the present disclosure. Alternatively, a separate actuator mechanism 200 may be used to move the injection mold 20 relative to the nozzle assembly 10.

Put another way, the gate 42 may be moved relative to the injection nozzle 12 and valve stem 14 (which may both remain stationary) by the action of the machine open/close actuator. Since the valve stem 14 does not move relative to the nozzle body 12, the use of a separate mechanism for retracting the valve stem within the nozzle body can be eliminated. Additionally, since multiple nozzle assemblies 10 may be disposed within the bushing plate 32, the open/close actuator according to the present disclosure may be used to eliminate the need for individual valve stem actuators for each nozzle assembly 10. This improvement may be achieved even if an actuator is used that is separate from the open/close actuator.

For example, according to one embodiment the actuator mechanism 200 may include an actuator 300, FIGS. 1 and 2, such as, but not limited to, a pneumatic piston, a hydraulic piston, an electromagnetic piston, an electric motor, or the like. A first end 301 of the actuator 300 may be linked, coupled or otherwise secured to the injection mold 20 and/or the adapter plate 28 and the other end 302 may be linked, coupled or otherwise secured to the bushing plate 32. The actuator 300 causes the injection mold 20 and adapter plate 28 to move a distance B′ along split line B between the open closed and open positions as shown in FIGS. 1 and 2, respectively.

Those skilled in the art will recognize that a wide range of actuator mechanisms 200 may be used to move the gate 42 relative to then injection nozzle 12. For example, the actuator mechanisms 200 may include one or more springs (not shown) disposed between the adapter plate 28 and the bushing plate 32 which takes advantage of the injection machine clamping force in order to move the gate 42 relative to the injection nozzle 12. Alternatively, a camming device (such as, but not limited to, an offset cam bolt or the like) may be linked or otherwise coupled to the plates 20, 28, 32 to provide the necessary motion. The present disclosure is not limited to any specific embodiment for providing this motion unless specifically claimed as such.

According to one embodiment, the present disclosure may feature one or more injection molds 20 having multiple mold cavities 26 wherein the gate regions 42 are opened/closed substantially simultaneously. Alternately, the present disclosure may also feature one or more injection molds 20 defining multiple mold cavities 26 wherein the gate regions 42 of the injection molds 20 and the nozzle assemblies 10 may be moved independently with respect to each other such that the opening/closing of a specific mold cavity 26 may be controlled independently of the other mold cavities 26.

Control systems using hydraulic fluid, pressurized air and electric motors in combination with numerous switches and a controller may be used to control both the positioning of the platens and the application and removal of clamp-up force for opening and closing the mold. A locking device may also engage the tie bars of the machine. According to one embodiment, positioning of the platens includes opening and closing the mold halves 22, 24 along split line A as well as positioning of the cavity plate 24 (and gate 42) in relation to the nozzle tip 12 and valve stem 14 such that the valve stem 14 engages the gate 42 and seals the mold cavity space 26.

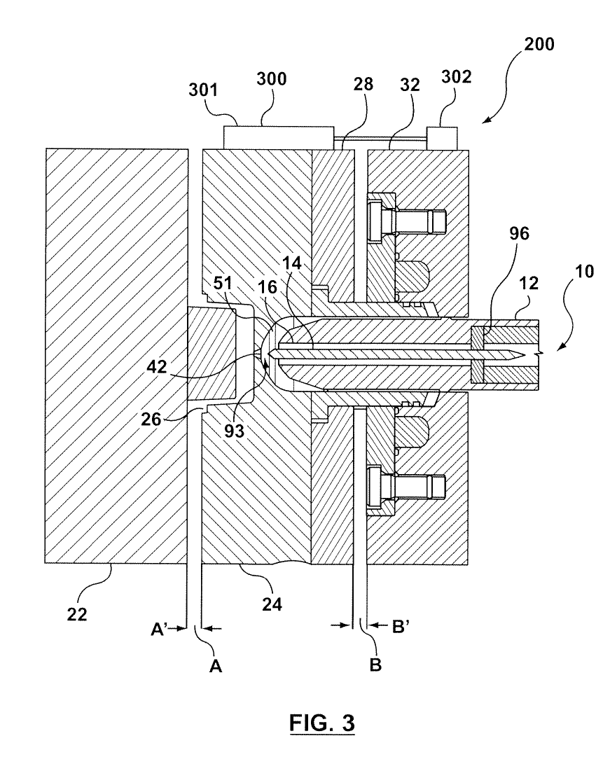

FIG. 3 is a sectional view of the valve gating system of the present disclosure illustrating the use of such in an injection-compression molding machine. In this exemplary embodiment, the gate 42 and the cavity plate 24 may be retracted along split line B from stationary platen 30 to allow material to flow through gate 42 and into mold cavity space 26. At the same time the core plate 22 may be separated slightly along split line A from cavity plate 24 to allow mold cavity space 26 filling later in the molding cycle.

The mold halves 22, 24 may be closed later in the injection cycle to compress the plastic material in the mold cavity space 26 after a predetermined amount of material has been injected. The gate 42 may be closed by moving the cavity plate 24 so that the gate 42 engages the valve stem 14.

While the present disclosure has been described wherein the injection mold 20 moves relative to the nozzle assembly 10, this is not a limitation of the present disclosure and the nozzle assembly 10 may be moved relative to the injection mold 20 provided the valve gating portion 93 (e.g., valve stem 14) remains substantially stationary with respect to the nozzle assembly 10. Additionally, while the present disclosure has been described wherein valve gating portion 93 includes a valve stem 14, this is not a limitation of the present disclosure.

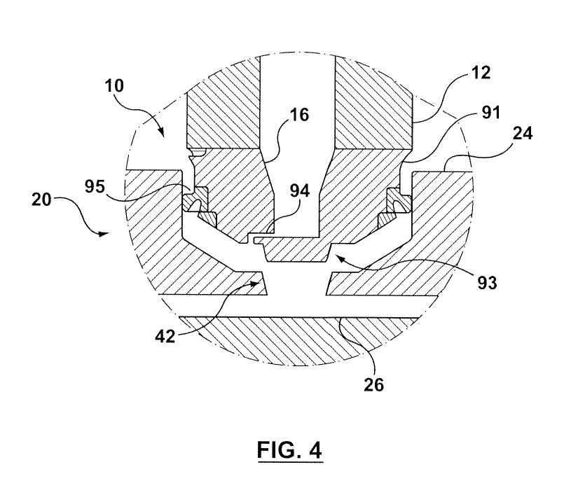

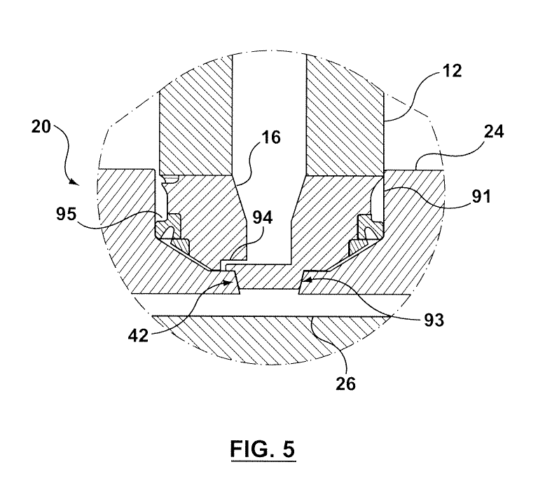

Referring to FIGS. 4 and 5, an alternative embodiment of a nozzle assembly 10 is shown in combination with an injection mold 20. The nozzle assembly 10 is shown in FIG. 4 in an open position and in FIG. 5 in a closed position as will be described in greater detail hereinbelow. According to this embodiment, the nozzle assembly 10 comprises a nozzle body or tip 12, a nozzle tip 91, and optionally, a ring seal 95 or the like that forms a seal between the nozzle assembly 10 and the injection mold 20 such that resin substantially cannot leak past the nozzle assembly 10.

The nozzle tip 91 may be removably secured to the nozzle body 12 in any manner known to those skilled in the art such as, but not limited to, a threaded connection or the like. Alternatively, the nozzle tip 91 may be an integral or unitary element with the nozzle body 12. For example, the nozzle tip 91 may be manufactured from a single piece of material or may be permanently joined to the nozzle body 12 (for example by welding or the like).

The nozzle tip 91 may comprise a valve gating portion 93 and a tip passageway 94. The tip passageway 94 is fluidly coupled to the melt channel 16. The valve gating portion 93 may be sized and shaped to seal against at least a portion of the gate 42 when the nozzle assembly 10 and/or injection mold 20 are moved towards each other as described above and shown in FIG. 5. Once the valve gating portion 93 seals against the gate 42, the valve gating portion 93 prevents the resin from flowing past the gate 42 and entering the mold cavity 26. Alternatively (or in addition), the valve gating portion 93 may comprise a tip passageway 94 that is positioned relative to the valve gating portion 93 such that when the nozzle assembly 10 and/or injection mold 20 are moved towards each other, the tip passageway 94 seals against a portion of the injection mold 20 thereby preventing the material from flowing past the gate 42 and entering the mold cavity 26 as shown in FIG. 5.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A method comprising:
transporting a molten material from a nozzle assembly to a mold cavity of an injection mold; and
moving said injection mold to a first position wherein a portion of said injection mold contacts a portion of said nozzle assembly and prevents the flow of said molten material into said mold cavity.

2. The method of claim 1 wherein transporting said molten material further comprises:
moving said injection mold to a second position wherein said portions of said injection mold and said nozzle assembly do not contact each other.

3. The method of claim 1 further comprising: moving said injection mold to said first position wherein said portion of said injection mold contacts a stationary valve stem of said nozzle assembly, wherein said portion of said injection mold seals against said stationary valve stem and prevents the flow of said molten material into said mold cavity.

4. The method of claim 3 wherein transporting said molten material further comprises:
moving said injection mold to a second position wherein said portion of said injection mold and said stationary valve stem do not contact each other.

5. The method of claim 1 further comprising:
activating an actuator coupled to said injection mold to open said mold cavity of said injection mold; and
activating said actuator to move said injection mold to said first position.

6. The method of claim 5 wherein transporting said molten material further comprises:
activating said actuator to move said injection mold to a second position wherein said portions of said injection mold and said nozzle assembly do not contact each other and said resin can flow through said nozzle assembly and into said mold cavity.

7. The method of claim 6 wherein transporting said molten material further comprises:
activating said actuator to open said mold cavity while said injection mold is in said second position.

8. The method of claim 6 further comprising:
activating said actuator to close said mold cavity of said injection mold while said injection mold is in said second position; and activating said actuator to open said mold cavity of said injection mold while said injection mold is in said first position.

9. A nozzle assembly comprising: a nozzle comprising:
a nozzle body comprising an internal flow channel configured to communicate resin from a source of resin with a mold cavity of an injection mold; and
a valve gating portion that is stationary with respect to said nozzle body and configured to engage said injection mold in a first position and prevent resin from flowing to said mold cavity.

10. The nozzle assembly of claim 9 wherein said valve gating portion further comprises:
a valve stem mounted within said internal flow channel and extending outward from an injection orifice of said nozzle.

11. The nozzle assembly of claim 9 wherein said valve gating portion further comprises:
a nozzle tip removeably secured to a distal end of said nozzle body.

12. The nozzle assembly of claim 9 further comprising:
a bushing configured to be secured to said injection mold and to surround at least a portion of an exterior surface of said nozzle.

13. The nozzle assembly of claim 12 further comprising:
an actuator for moving said injection mold and said bushing between said first and said second positions.

14. A valve gating system comprising:
an injection mold comprising a mold cavity and a gate;
a nozzle assembly comprising:
a nozzle body comprising an internal flow channel configured to communicate resin from a source of resin with said mold cavity of said injection mold; and a valve gating portion that is stationary with respect to said nozzle body; and
an actuator coupled to said injection mold and configured to move said injection mold relative to said nozzle assembly between a first position wherein said valve gating portion engages said gate of injection mold and prevents resin from flowing to said mold cavity and a second position wherein said valve gating portion permits said resin to flow into said mold cavity.

15. The system of claim 14 wherein said injection mold comprises a mold plate and a cavity plate defining said mold cavity, wherein said actuator is coupled to said injection mold to move at least one of said mold and said cavity plates between an open and a closed position.

16. The system of claim 15 wherein said actuator is coupled to said injection mold such that said injection mold is simultaneously in said open position and said first position.

17. The system of claim 15 wherein said actuator is coupled to said injection mold such that said injection mold is simultaneously in said closed position and said first position.

18. The system of claim 14 wherein said valve gating portion further comprises:
a valve stem mounted within said internal flow channel and extending outward from an injection orifice of said nozzle.

19. The system of claim 14 wherein said valve gating portion further comprises:
a nozzle tip removeably secured to a distal end of said nozzle body.

20. The system of claim 14 further comprising:
a bushing configured to be secured to said injection mold and to surround at least a portion of an exterior surface of said nozzle, wherein said bushing moves along a portion of said nozzle as said injection mold moves between said first and said second positions.
